(19) United States
(12) Patent Application Publication
(10) Pub. No.: US 2024/0316680 A1
(43) Pub. Date: Sep. 26, 2024

(54) FLOATING CORE TUBE IN WELDING TORCH CABLES

(71) Applicant: Illinois Tool Works Inc., Glenview, IL (US)

(72) Inventor: Bradley Eugene Whipple, South Woodslee (CA)

(21) Appl. No.: 18/609,508

(22) Filed: Mar. 19, 2024

Related U.S. Application Data
(60) Provisional application No. 63/453,808, filed on Mar. 22, 2023.

(51) Int. Cl. B23K 9/32

(52) U.S. Cl. CPC B23K 9/323

(57) ABSTRACT

A welding cable connection assembly for an electric welding torch is provided. For example, the welding cable connection assembly includes a connector having an interior cavity to receive a portion of a floating core tube of a welding cable. A fastener is arranged about an outer circumference of the welding cable to fix a position or arrangement of the welding cable relative to the connector.

### CROSS REFERENCE TO RELATED APPLICATIONS

This application is a Non-Provisional Patent application claiming priority to U.S. Provisional Patent Application No. 63/453,808 entitled “Floating Core Tube In Welding Torch Cables” filed Mar. 22, 2023, which is herein incorporated by reference in its entirety.

### BACKGROUND

In an electric arc welding process, it is known to use a power cable for conducting current, shielding gas, and electrode wire through a welding torch. The power cable is often referred to as an unicable for an air-cooled torch, which generally includes a core tube, copper cabling, lead wires, and insulation jacket. Typically, such a cable is connected to other torch parts by way of either a crimped or threaded compression fitting. One end of the cable is fastened to a wire feeder by way of a mating pin (or power pin), and the other end is fastened to a torch body with a gooseneck or conductor tube of the welding torch. These connections are fixed and unmoving.

The power cable provides major flexibility to the torch, such that the welding arc can be applied at various locations. However, conventional fixed connections limit the movement of the copper bundles within the unicables and creates stress, leading to eventual failure of the electrical connection of the welding torch or cable.

Conventional cables are installed in fixed positions, and during manipulation of the torch by a user or a robot, the cable bends as the torch is angled towards a weld. In some robotic designs, this is problematic as the cable can be subjected to severe mechanical wear such that the fixed cable connections or the unicable fail. In the case of a mounted welding torch, any movement of the robotic arm that extends beyond a given angle puts stress on the cable and the cable connection. When the cable overextended, the stress can cause mechanical and/or electrical failure of the cable.

### SUMMARY

The present disclosure is directed to a welding cable connection assembly for an electric welding torch. For example, the welding cable connection assembly includes a connector having an interior cavity to receive a portion of a floating core tube of a welding cable. A fastener is arranged about an outer circumference of the welding cable to fix a position or arrangement of the welding cable relative to the connector.

These and other features and advantages of the invention will be more fully understood from the following detailed description of the invention taken together with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example robotic welding system, in accordance with aspects of this disclosure.

FIGS. 2A and 2B illustrate perspective and cross-sectional views of an example unicable construction, in accordance with aspects of this disclosure.

FIGS. 3A and 3B illustrate cross-sectional views of an example welding cable connection, in accordance with aspects of this disclosure.

FIGS. 4A and 4B illustrate cross-sectional views of an example robotic welding system with an incorporated welding cable connection, in accordance with aspects of this disclosure.

FIGS. 5A to 5E illustrate cross-sectional views of an example welding cable connection with a floating core tube, in accordance with aspects of this disclosure.

FIG. 6 illustrates a cross-sectional view of another example welding cable connection with a floating core tube, in accordance with aspects of this disclosure.

The figures are not necessarily to scale. Where appropriate, similar or identical reference numbers are used to refer to similar or identical components.

### DETAILED DESCRIPTION

This disclosure relates to electric welding generally, and more particularly to flexible power connections for connecting an electrical supply power cable to an electric welding torch body. In particular,

The disclosed welding cable assembly eliminates areas of high stress where conventionally a barb connection is located, allowing the core tube to “float” within the connector, thereby increasing cable life. The core tube is retained within the connector and cannot be pulled out of the unicable once conductive (e.g., copper) strands are crimped onto the connector. By having the core tube float within the connector, the bending stress within the cable is reduced.

The disclosed rotating power connector advantageously allows for rotation of the welding torch relative to the unicable while providing continual electrical connection at the high current levels employed in welding applications.

The disclosed welding cable connection assembly provides a solution to issues impacting cable life and survivability when the cable is bent to extreme angles during use. The connection between the cable and the connector provides reliable electrical contact while extending the life of the cable, all while allowing the cable to be articulated over a broader range (e.g., up to or beyond a 90° angle) from an initial state (e.g., typically extended in a straight line).

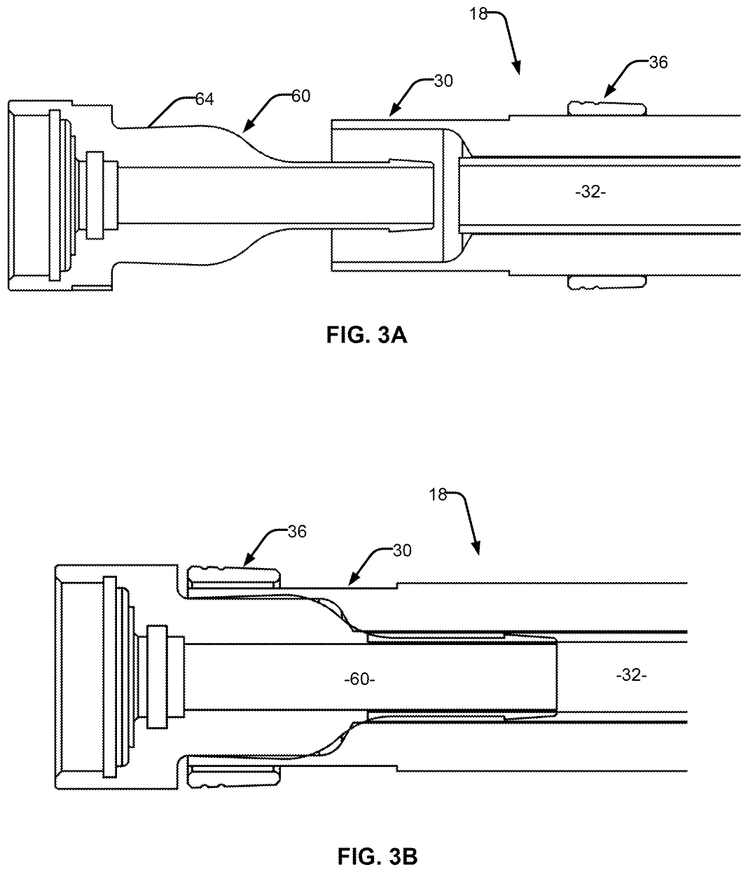

Employing a welding cable connection assembly as disclosed herein serves to increase production throughput due to simplicity of the design. For instance, manufacturing of the cable does not require cutting a core tube, and then pealing back copper strands of the cable to then attach the core tube to a barb fitting (e.g., as shown as flared tip 70 and ridge 68 on connection 60 of FIG. 3A). Thus, the cable and core tube can be cut and simply slid into the connector, with the copper strands sliding over an external surface of the connector. Once so arranged, the copper strands can be mechanically fixed, mounted, and/or supported (e.g., crimped) onto the connector.

Advantageously, the disclosed reduces strain on the cable at the point of connection, thereby increasing the useful life of the cable. Further, the arrangement of the wire strands about the connector (with the floating core tube inserted into the connector) reduces stress inside the cable assembly. The enhanced design may also increase bend articulation limits on the cable within a robotic arm, for instance.

In addition to the aforementioned manufacturing benefits, the arrangement of the core tube and surrounding wire strands allows for simpler and faster integration with the connector, offering cost and time savings, as well as a more robust connection.

Additionally, the disclosed connection assembly is dimensioned to fit into housings, robotic arms, etc., of existing welding systems, thereby allowing for hassle-free exchange with existing power connections and cables.

In disclosed examples, a welding cable connection assembly for an electric welding torch is provided. The assembly includes a connector having an interior cavity to receive a portion of a core tube of a welding cable; and a fastener positioned at an interface of the connector and the welding cable to fix a position of the welding cable relative to the connector.

In some examples, the assembly further includes one or more seals arranged within a radial space exposed from the interior cavity of the connector, the one or more seals to contact an outer circumference of the core tube.

In some examples, the core tube is a hollow tube configured to convey a shielding gas to the electric welding torch.

In some examples, the connector comprises a first end to receive the core tube and a second end to connect to another connector or the electric welding torch.

In some examples, the assembly connects the welding cable to a robotic welding torch.

In some examples, the connector further comprises an external surface configured to receive multiple conductive strands of the welding cable enveloping the connector. In examples, the core tube extends a distance into the inner cavity equal a distance the multiple strands extend over the external surface. In examples, the external surface has a circumference smaller than a circumference of the multiple conductive strands in contact with the core tube along a length of the welding cable.

In some examples, one or more of the connector or the fastener are constructed of a conductive material.

In some examples, the fastener is a crimp or a weldment.

In some examples, the floating core tube is constructed of one or more of a metal, an alloy, a polymer, or a combination thereof.

In some disclosed examples, a welding system includes a welding torch; a welding cable connecting the welding torch to a wire feeder, the welding cable having a core tube surrounded by multiple conductive strands; a connector having an interior cavity to receive a portion of the core tube; and a fastener positioned at an interface of the welding cable to fix a position or arrangement of the welding cable relative to the connector.

In some examples, the connector further comprises an external surface configured to receive multiple conductive strands of the welding cable enveloping the connector.

In some examples, system further includes one or more seals arranged within a radial space exposed from the interior cavity of the connector, the one or more seals to contact an outer circumference of the core tube.

In some examples, the connector is configured to be inserted into a connector or the welding torch to connect the welding cable to the welding torch.

In some examples, the welding system is an automated robotic welding system.

In some examples, the core tube is inserted to the connector such that the core tube is operable to slide in or out of the connector in response to movement of the cable.

In some examples, the core tube is a hollow tube configured to convey a shielding gas to the electric welding torch.

In some examples, the fastener is aligned with one or more of the interior cavity, the portion of the core tube and the multiple conductive strands.

In some disclosed examples, a connector includes an interior cavity to receive a portion of a core tube of a welding cable; and an extended portion the connector support conductive strands of the welding cable, wherein the connector is configured to receive a fastener at an external circumference of the welding cable, the fastener being aligned with one or more of the interior cavity, the extended portion, the portion of the core tube and the conductive strands.

As used herein, the terms “first” and “second” may be used to enumerate different components or elements of the same type, and do not necessarily imply any particular order.

The term “welding-type system,” as used herein, includes any device capable of supplying power suitable for welding, plasma cutting, induction heating, Carbon Arc Cutting-Air (e.g., CAC-A), and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “torch,” “welding torch,” “welding tool” or “welding-type tool” refers to a device configured to be manipulated to perform a welding-related task, and can include a hand-held welding torch, robotic welding torch, gun, gouging tool, cutting tool, or other device used to create the welding arc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW, e.g., TIG), shielded metal arc welding (SMAW), spray, short circuit, CAC-A, gouging process, cutting process, and/or any other type of welding process.

As used herein, the term “welding program” or “weld program” includes at least a set of welding parameters for controlling a weld. A welding program may further include other software, algorithms, processes, or other logic to control one or more welding-type devices to perform a weld.

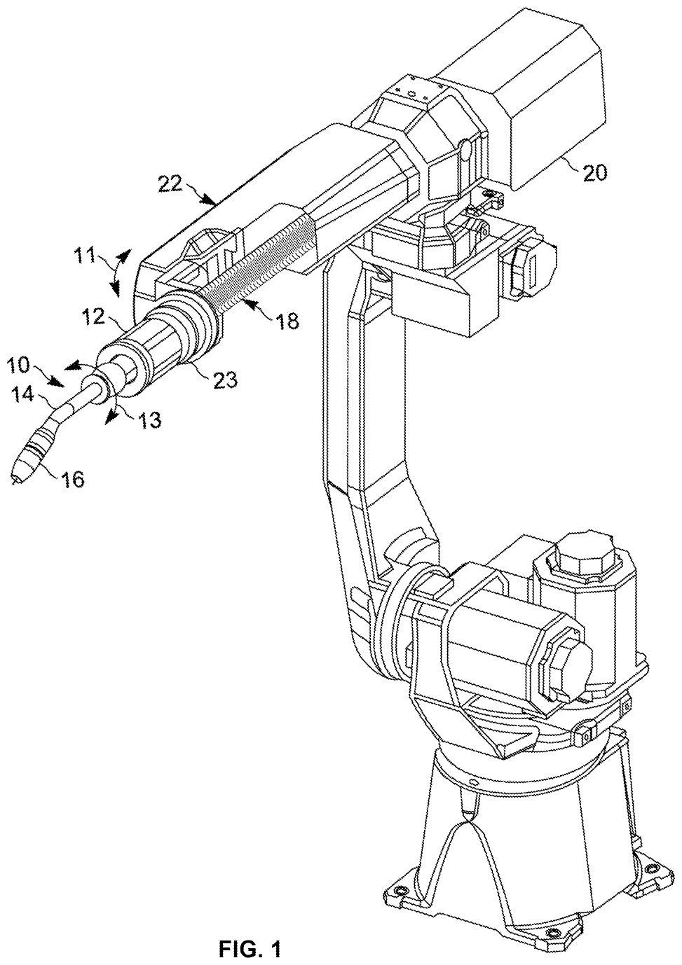

Turning now to the figures, FIG. 1 provides a perspective view of an example robotic welding system employing an example welding cable connection assembly 100. An electric welding torch 10 (e.g., a gas metal arc welding (GMAW) torch, a metal inert gas (MIG) torch, etc.) is comprised of a torch body having a main housing 12, a gooseneck 14, and a contact tip or nozzle assembly 16, a power cable, such as a unicable assembly 18, and a power pin (not shown) that mates with the wire feeder 20. The shielding gas, electrical current, and a consumable electrode (e.g., a welding wire) are channeled through the torch 10 to output a welding arc at the nozzle assembly 16.

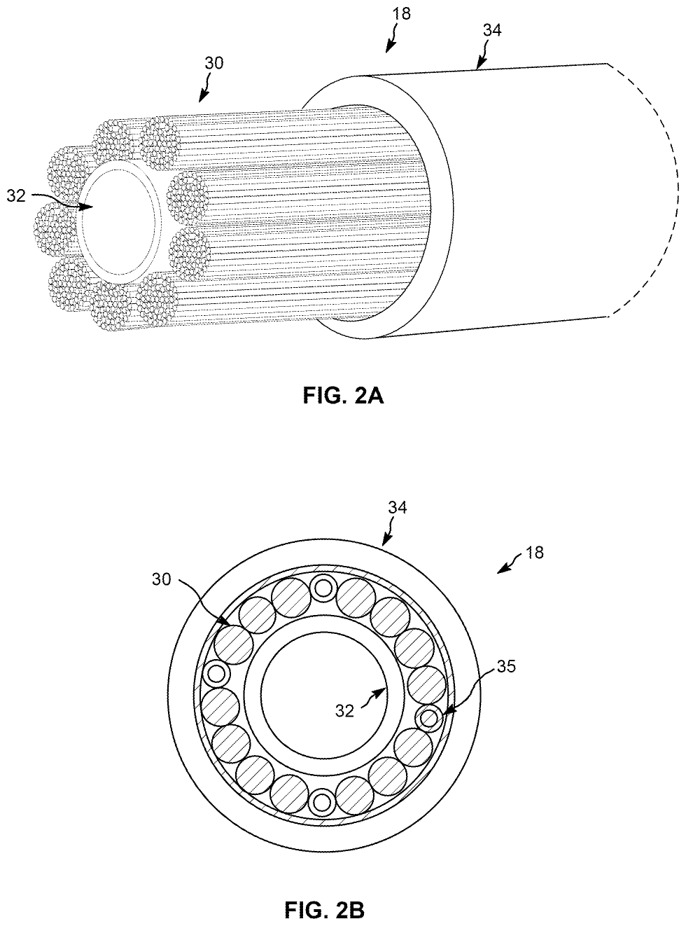

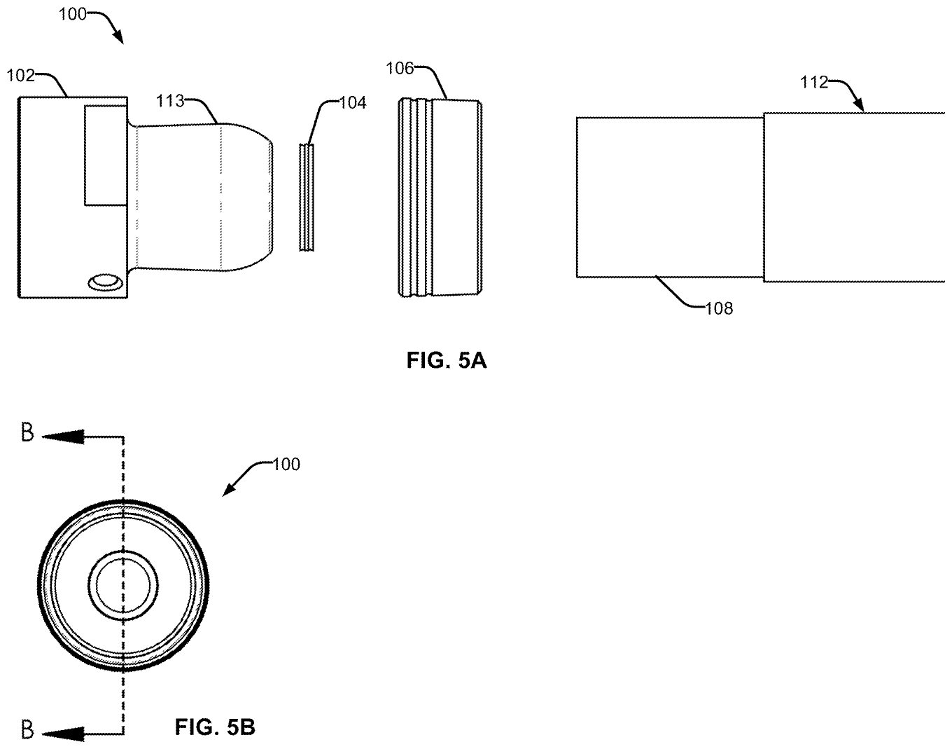

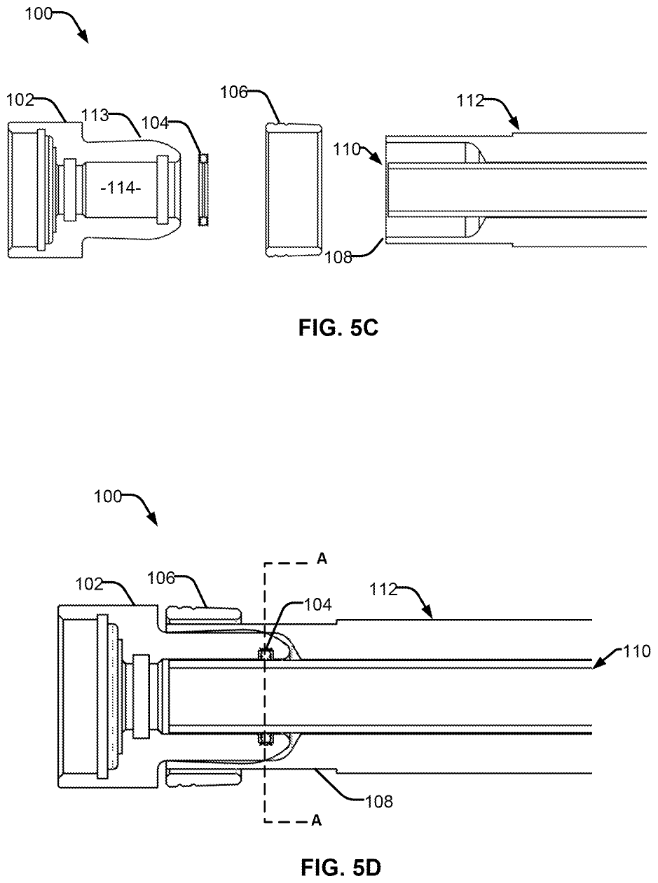

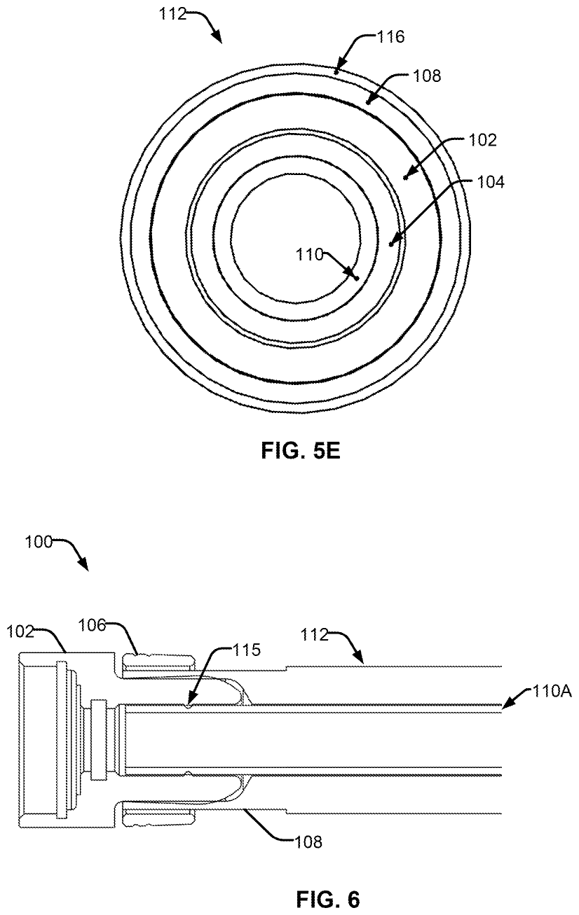

In some examples, an example welding cable connection assembly (e.g., welding cable connection assembly 100 of FIGS. 5A to 5E) is arranged within a robotic arm 22 (e.g., the main housing 12), providing a conducting assembly between the unicable assembly 18 and the torch 10. As shown in FIGS. 2A and 2B, the unicable assembly 18 may include one or more of a core tube 43, metallic/copper wire bundles 30, a sheath 34, and/or shielded lead wires 35, as a non-limiting list of examples. FIG. 2B provides a cross-sectional view of the unicable 18. For examples, individual conductors (e.g., metallic, copper, etc.) are made of multiple smaller strands as well as insulated wire leads (e.g., communication leads) are wrapped within those copper conductors.

Returning to FIG. 1, the unicable 18 may be connected to a wire feeder 20 opposite the main housing 12 of the welding torch 10. The gooseneck 14 is operatively connected to a forward end of the main housing 12 and allows for the communication of the consumable electrode, the shielding gas, and/or the welding current to the nozzle assembly 16 mounted on the gooseneck. The welding torch 10 is coaxially mounted to the robotic arm 22 such that the unicable 18 is arranged along the center axis of the robotic arm 22. However, the welding torch 10 may be mounted to a robotic arm in a disposition other than a coaxially mounted disposition. In some examples, the robotic arm 22 is configured to bend and/or rotate the welding torch 10 in direction 11, as well as bend and/or rotate in direction 13, generally about the center axis of the robotic arm 22. For instance, a motor or other actuator 23 is employed to control movement of the welding torch 10 via the main housing 12 in one or more directions 13.

In some examples, the assembly 100 is configured to connect to a rotating power connector (RPC), which can be the housing 12 itself and/or replace the housing. In some additional or alternative examples, the assembly 100 may be used to connect directly into a torch (e.g., a robotically mounted torch and/or a manual torch). The assembly 100 may be suitable for use on a variety of connections, such as for connecting auxiliary devices.

The wire feeder 20 feeds the welding wire through the unicable 18, main housing 12, gooseneck 14, and ultimately through an opening in the contact tip/nozzle assembly 16 at the forward end of the welding torch 10. The welding wire, when energized for welding, carries a high electrical potential. When the welding wire arcs with metal workpieces, an electrical circuit is completed and current flows through the welding wire, across the arc to metal workpieces and to a ground or other type of current return. The arc causes the welding wire and the metal of the workpieces to melt, thereby joining the workpieces as the melt solidifies.

FIGS. 3A and 3B illustrates an example power connector configured with an integrated direct crimp-on connection 60 (e.g., a crimped-style fitting, a compression fitting, a threaded compression fitting, etc.). In examples, conductive wires 30 (e.g., copper wires) of the unicable 18 are crimped on the tapered surface 64 via a crimp or ring 36 to form a solid electric connection between wires 30 of the unicable 18 and the crimp-on connection 60.

The crimp-on connection 60 includes a male connection with a flared tip 70 and ridge 68, such that a core tube 32 from the unicable 18 is secured by a snap-in feature. FIG. 5 provides an illustration of the example crimp-on connector 60 extending into the core tube 32.

Conventionally, during assembly an operator will move the copper strands 30 out of the way and remove a small section of the core tube 32 to insert the connection 60 into the unicable 18. The core tube 32 is then flared out to increase the I.D. to make it easier to install over top of the barb fitting, as shown in FIG. 3B. The core tube 32 is installed with the connection 60 fitting within (often with application of an adhesive), and the copper strands 30 are folded back over the outer diameter of the connection 60. The copper ring 36 is then mechanically crimped inward over and around the copper strands 30 to mechanically bond the wires to the connector 60.

The unicable 18 is constructed with two connectors, one on either end of the unicable 18, fixed to each end through a similar process. Once the copper ring 36 is crimped down onto the copper strands 30, the cable connectors are not meant to be removed from the unicable 18.

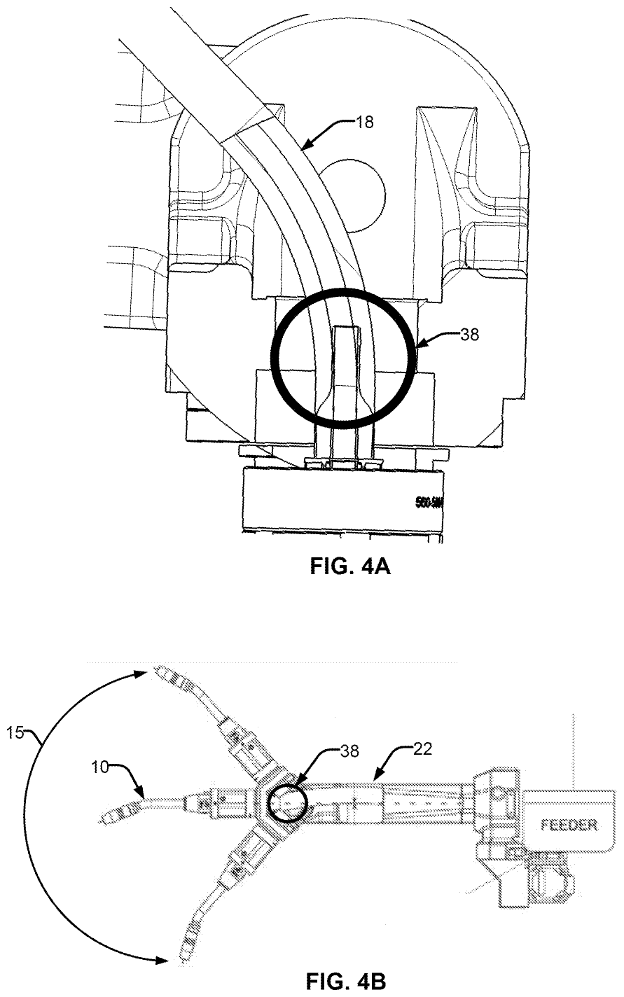

As shown in the example of FIG. 4A, a frailty of conventional designs is that when the unicable 18 is bent while installed on the robot wrist (generally identified at area 38), considerable stress is put on the unicable 18, and therefore the core tube 32 within. By nature of where the robot arm/wrist articulates, the bend happens close to the location of the connection 60 (e.g., the barb fitting). Over time, this stress wears through the core tube 32 and then into the copper strands 30, which can result in breakage and/or a catastrophic failure of the cable.

FIG. 4B illustrates movement of a torch 10 attached to a robotic arm 22. As the torch 10 moves about arc 15, there may be a degree of movement in opposite direction in the cable (e.g., about 1.5 inches) from its extended (e.g., straight) state. As the cable bends, the length of the cable changes. If a position of both ends of the core tube 32 are fixed, however, that stress builds up and may cause the core tube 32 to disengage from the connector or other failure to the cable.

The disclosed welding cable assembly eliminates areas of high stress where conventionally a barb connection is located, allowing the core tube to “float” within the connector, thereby increasing cable life. The core tube is retained within the connector and cannot be pulled out of the unicable once the conductive strands are crimped onto the connector. By having the core tube float within the connector, the bending stress within the cable is reduced.

FIG. 5A illustrates a breakout view of components of an example welding cable connection assembly 100 employing a floating core tube 110, as disclosed herein. A unicable 112 (which may be similar to unicable 18) incorporates two conductive connectors (e.g., connectors 102) on one or both ends of the unicable 112 to secure the conductive strands 108 and/or the core tube 110 thereto. For example, the core tube 110 is the conduit for shielding gas and/or a liner for welding wire as they pass from the wire feeder 20 to the front of the welding torch 10.

Use of the welding cable connection assembly 100 provides a degree of flexibility and/or support at a bend (e.g., at a joint identified as area 38 of FIGS. 4A and 4B). For example, when the connector 102 is connected to an unicable, articulation of the unicable may compress, extend, or bend the conductive strands of the cable surrounding the connector 102. By use of the welding cable connection assembly 100, movement of the rotating arm does not disrupt contact between the connector 102 and the cable 112 and/or the floating core tube 110.

As shown in FIG. 5C, illustrating a cross-sectional image of the assembly 100 along line B-B of FIG. 5B, a connector 102 is configured to receive a seal 104 (e.g., an O-ring). The floating core tube 110 is operable to be inserted into an interior cavity 114 of the connector 102, with multiple conductive strands 108 within a welding cable 112 enveloping an external surface 116 of the connector 102. A fastener or support ring 106 (e.g., a metallic crimp ring, a band, a wire, etc.) is used to mechanically fix the position and/or arrangement of the conductive strands 108 relative to the connector 102. In some examples, the support ring 106 is constructed of a metallic and/or conductive material, such as copper. For instance, fixing the fastener 106 (e.g., crimping, welding) around the conductive strands 108 causes the strands to compress against one another and the fastener, such that the strands are pressed tightly against the connector, flattening and spreading out around that surface

FIG. 5D illustrates the example welding cable connection assembly 100 with the components fully assembled. For instance, once assembled, the welding cable 112 is secured to the connector 102 and the core tube 110 is captured within the interior cavity 114 of the connector 102. In the illustrated examples, the floating core tube 110 is operable to move freely within the welding cable connection assembly 100 as a length of the cable varies with movement of the robotic arm 22.

This flexibly serves to reduce stress in the cable, the conductive strands 108, and/or the tube 110. This view shows the interior cavity of the connector and how the core tube is allowed to travel freely within it. The shielding gas that flows through the core tube 110 is sealed from leaking out of the connector via the seal 104 situated in a radial space exposed from the interior cavity 114 of the connector 102. The seal 104 allows for axial movement of the core tube 110 as the cable 112 bends, and any changes in the length of the cable 112, while sealing any shielding gas from leaking.

In the example of FIG. 5D, the support ring 106 is aligned and/or overlaps with one or more components of the assembly 100. As shown, the support ring 106 is arranged outside sheathing of the cable 112, and overlaps with a portion of the conductive strands 108 and an extended portion 113 of the connector 102. As the support ring 106 applies tension on the conductive strands 108 at a position away from the pivot point of the floating tube core 110, less strain is experienced at the entrance point of connector. Thus, the tube 110 can pivot, rotate, extend from and/or be further inserted into the cavity 114 of the connector 102 without application of excessive force on the components.

In some examples, an internal surface of the support ring 106 may have a threaded pattern. This allows the support ring to tighten about the conductive strands 108 when rotated about the external surface of the strands. In some examples, an external surface of the connector 102 may additionally or alternatively have a threaded pattern. The support ring and connector may have complementary threaded patterns to allow for a screw-tightening effect.

FIG. 5E illustrates a cross-sectional view of the line A-A shown in FIG. 5D. The layers of the assembly are provided, with an outer jacket 116 of the cable surrounding the conductive strands 108, which in turn surround the connector 102. The O-ring 104 is arranged within the channel of the connector, and creates a seal with an outer surface of the core tube 110.

Although some examples are illustrated as including an O-ring 104 to seal shielding gas within the floating core tube assembly 100, some examples can employ an internal barb-type connection 115 within a core tube 110A to seal the shielding gas from escaping the assembly, as shown in FIG. 6. The barb-type connection 115 can create pressure between the floating core tube 110A and the connector 102, and may be used independently of any O-ring or other sealant. In some examples, both a barb-type connection and an O-ring are employed.

As provided in the disclosed figures, the connector assembly 100 allows for the transfer of electricity, as electrical current may pass from the wires 108 of the unicable 112 through contact with the connector 102. The interface between the outer surface on an extended portion or extension 113 of the connector and the conductors 108 are secured by a crimp 106 around an outer circumference of the cable/wire 112. For instance, the connector 102 and the wires 108 may be made of an electrically conductive materials. In some examples, the cable 112 may be enveloped with an insulating material such as a plastic or similar, thereby shielding the outside of the cable 112 from short-circuiting to external components and/or devices (e.g., the robotic arm 22).

In some examples, the core tube 110 can be constructed of one or more materials, including metals, alloys, polymers, and/or a combination thereof. Some materials used in construction of the core tube(s) include steel mono coil, Hytrel®, and/or Teflon®, as a list of non-limiting examples.

In some examples, one or more conductive materials can be used to construct the connector(s) 102, such as such as copper, bronze, aluminum, silver, metal alloys, and/or other conductive materials.

In some examples, a cable can incorporate the disclosed floating core tube assembly on both ends of the cable, at the welding torch end only, or at the power supply, wire feeder, or other supply source end only.

Some examples employ application of a heat shrink tubing about the outside of the circumference of the cable (e.g., over a top of the conductive strands and/or outer jacket of the cable). Such an external heat shrink tubing could be used to seal against shielding gas leakage. This may replace or enhance the use of the O-ring, while allowing the core tube to float within the connector.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A welding cable connection assembly for an electric welding torch comprising:
a connector having an interior cavity to receive a portion of a core tube of a welding cable; and
a fastener positioned at an interface of the connector and the welding cable to fix a position of the welding cable relative to the connector.

2. The welding cable connection assembly of claim 1, further comprising one or more seals arranged within a radial space exposed from the interior cavity of the connector, the one or more seals to contact an outer circumference of the core tube.

3. The welding cable connection assembly of claim 1, wherein the core tube is a hollow tube configured to convey a shielding gas to the electric welding torch.

4. The welding cable connection assembly of claim 1, wherein the connector comprises a first end to receive the core tube and a second end to connect to another connector or the electric welding torch.

5. The welding cable connection assembly of claim 1, wherein the assembly connects the welding cable to a robotic welding torch.

6. The welding cable connection assembly of claim 1, wherein the connector further comprises an external surface configured to receive multiple conductive strands of the welding cable enveloping the connector.

7. The welding cable connection assembly of claim 6, wherein the core tube extends a distance into the inner cavity equal a distance the multiple strands extend over the external surface.

8. The welding cable connection assembly of claim 6, wherein the external surface has a circumference smaller than a circumference of the multiple conductive strands in contact with the core tube along a length of the welding cable.

9. The welding cable connection assembly of claim 1, wherein one or more of the connector or the fastener are constructed of a conductive material.

10. The welding cable connection assembly of claim 1, wherein the fastener is a crimp or a weldment.

11. The welding cable connection assembly of claim 1, wherein the floating core tube is constructed of one or more of a metal, an alloy, a polymers, or a combination thereof.

12. A welding system comprising:
a welding torch;
a welding cable connecting the welding torch to a wire feeder, the welding cable having a core tube surrounded by multiple conductive strands;
a connector having an interior cavity to receive a portion of the core tube; and
a fastener positioned at an interface of the welding cable to fix a position or arrangement of the welding cable relative to the connector.

13. The welding system of claim 12, wherein the connector further comprises an external surface configured to receive multiple conductive strands of the welding cable enveloping the connector.

14. The welding system of claim 12, further comprising one or more seals arranged within a radial space exposed from the interior cavity of the connector, the one or more seals to contact an outer circumference of the core tube.

15. The welding system of claim 12, wherein the connector is configured to be inserted into a connector or the welding torch to connect the welding cable to the welding torch.

16. The welding system of claim 12, wherein the welding system is an automated robotic welding system.

17. The welding system of claim 12, wherein the core tube is inserted to the connector such that the core tube is operable to slide in or out of the connector in response to movement of the cable.

18. The welding system of claim 12, wherein the core tube is a hollow tube configured to convey a shielding gas to the electric welding torch.

19. The welding system of claim 12, wherein the fastener is aligned with one or more of the interior cavity, the portion of the core tube and the multiple conductive strands.

20. A connector comprising:
an interior cavity to receive a portion of a core tube of a welding cable; and
an extended portion the connector support conductive strands of the welding cable, wherein the connector is configured to receive a fastener at an external circumference of the welding cable, the fastener being aligned with one or more of the interior cavity, the extended portion, the portion of the core tube and the conductive strands.
